(19) United States
(12) Patent Application Publication
(10) Pub. No.: US 2012/0173988 A1
(43) Pub. Date: Jul. 5, 2012

(54) METHOD AND APPARATUS FOR SHARING CONTENT SERVICE FOR WEB PAGE AND SYSTEM FOR PROVIDING THE SAME

(75) Inventors: Thu Hong TRAN, Seoul (KR); Won-Seok KWON, Gyeonggi-do (KR); Jin PARK, Gyeonggi-do (KR)

(73) Assignee: Samsung Electronics Co., Ltd., Gyeonggi-Do (KR)

(21) Appl. No.: 13/342,339

(22) Filed: Jan. 3, 2012

(30) Foreign Application Priority Data
Jan. 4, 2011 (KR) 10-2011-0000681

(51) Int. Cl. G06F 3/048

(52) U.S. Cl. 715/738

(57) ABSTRACT

Disclosed is a method and system for sharing content of a web page between first and second terminals. The first terminal receives the web page from a server and extracts region information corresponding to a region selected by a user from the web page. The first terminal maps URL information corresponding to the web page to the extracted region information and transmits the mapped information to the second terminal. The second terminal parses the mapped extracted region information and URL information, receives the corresponding web page from the web server based on the parsed URL information, recognizes a region corresponding to the extracted region information in the received web page, and activates the region.

### CLAIM OF PRIORITY

This application claims priority under 35 U.S.C. §119(a) to a Korean Patent Application entitled “Method and Apparatus for Sharing Content Service for Web Page and System for Providing the Same” filed in the Korean Industrial Property Office on Jan. 4, 2011 and assigned Ser. No. 10-2011-0000681, the contents of which are incorporated herein by reference.

### BACKGROUND

1. Technical Field

This disclosure relates to a method and an apparatus for sharing content of a web page, particular between portable wireless terminals.

2. Description of the Related Art

In general, a portable terminal refers to a portable electronic device having portability and including at least the functions of data communication, inputting and outputting information, and storing data. As functionality of portable terminals such as smartphones has expanded, portable terminals have evolved with complex functions such as camera operations, reproducing music and video files, playing games, receiving broadcasts, surfing the Internet, etc. Thus portable terminals have been implemented in a form of a complex multimedia devices.

For the portable terminal implemented in a form of the multimedia device, new attempts are variously applied to execute complex functions with the use of added hardware and/or software. As an example, there is a user interface environment in which a user easily and conveniently searches for or selects a desired function.

However, when a user accesses the Internet through the portable terminal and finds useful web page contents displayed while browsing, it is difficult for the user to easily share the displayed contents with users of other terminals.

### SUMMARY

In one aspect, a method and system are provided for sharing content of a web page between first and second terminals. The first terminal receives the web page from a server and extracts region information corresponding to a region selected by a user from the web page. The first terminal maps URL information corresponding to the web page to the extracted region information and transmits the mapped information to the second terminal. The second terminal parses the mapped extracted region information and URL information, receives the corresponding web page from the web server based on the parsed URL information, recognizes a region corresponding to the extracted region information in the received web page, and activates the region.

In another aspect, a method of sharing content of a web page is provided, in which an HTML link is generated, the link corresponds to a region of the web page selected by a user at a first terminal. The HTML link is received at a second terminal. The first terminal transmits the HTML link and the content included in the selected region of the web page to the second terminal. The second terminal receives and displays the transmitted content of the selected region.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a flowchart of a method of sharing a content service for a web page according to an embodiment of the present disclosure;

FIG. 2 is a diagram schematically illustrating a system for sharing a content service for a web page according to an embodiment;

FIG. 3 is a flowchart of a method of sharing a content service for a web page according to another embodiment of the disclosure;

FIG. 4A is an illustrative view showing example screens in a system for sharing a content service for a web page according to another embodiment;

FIG. 4B shows an example display of content in a receiving terminal of FIG. 4A; and

FIG. 5 is a functional block diagram of an example portable terminal configured to share a content service of a web page according to an embodiment.

### DETAILED DESCRIPTION OF EXEMPLARY EMBODIMENTS

Hereinafter, exemplary embodiments of the present disclosure will be described with reference to the accompanying drawings. Further, specific matters found in the following description are provided only to help general understanding of the present invention so that those skilled in the art will appreciate that various modifications, additions, and substitutions are possible, without departing from the scope and spirit of the invention as disclosed in the accompanying claims.

Embodiments of the present disclosure are intended to separately select only contents which a user desires to share in a web page and then transmit the selected contents to another user's terminal during or subsequent to the use of an internet service in a portable terminal. Embodiments provide a technology in which a plurality of contents in a web page can be separately and freely selected and transmitted. An adaptive Uniform Resource Locator (URL)-locatable file rendering service can be provided for each user or group, to easily share a variety of contents.

Briefly, the technology may be implemented by means of a user separately and freely selecting contents contained in a web page displayed on the user's portable terminal (first terminal). The web page is obtained by accessing a wireless portal server or a wired internet server using a wireless internet service to browse various contents provided by the corresponding server. Region information, such as coordinates, of a region of the web page containing the selected contents is extracted. URL information of the web page is mapped to the region information. The region and mapped information is transmitted to another (second) terminal with which the user desires to share the contents. The second terminal parses the extracted region information and mapped URL information, and then requests web page corresponding to the URL from the web server. Upon receiving the web page, the second terminal activates a region corresponding to the extracted region information in the received web page.

A portable terminal with a touch screen according to an embodiment of the present disclosure is configured to communicate with a server through an IP (Internet Protocol) network. The portable terminal can be embodied as any of multiple types of information communication devices and multimedia devices such as a digital broadcasting terminal, a Personal Digital Assistant (PDA), a smart phone, a 3G terminal, for example, an IMT-2000 (International Mobile Telecommunication 2000) terminal, a WCDMA (Wideband Code Division Multiple Access) terminal, a GSM/GPRS (Global System for Mobile Communication Packet Radio Service), a UMTS (Universal Mobile Telecommunication Service) terminal, an LTE terminal, etc.

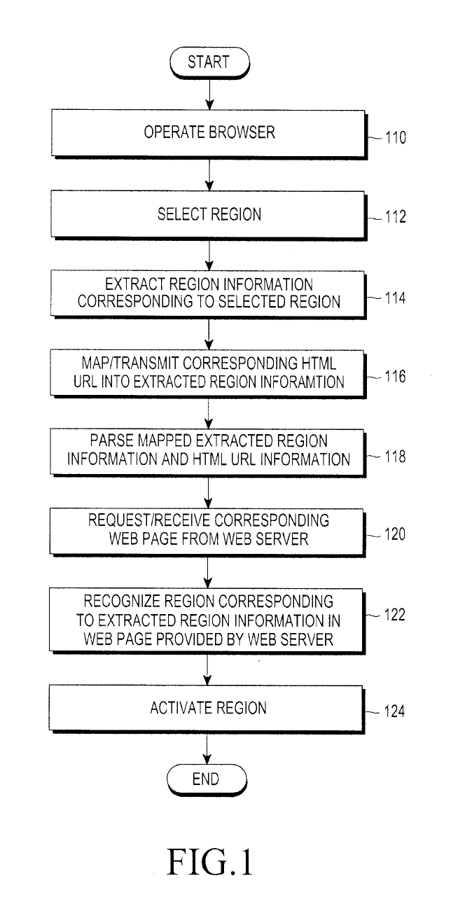

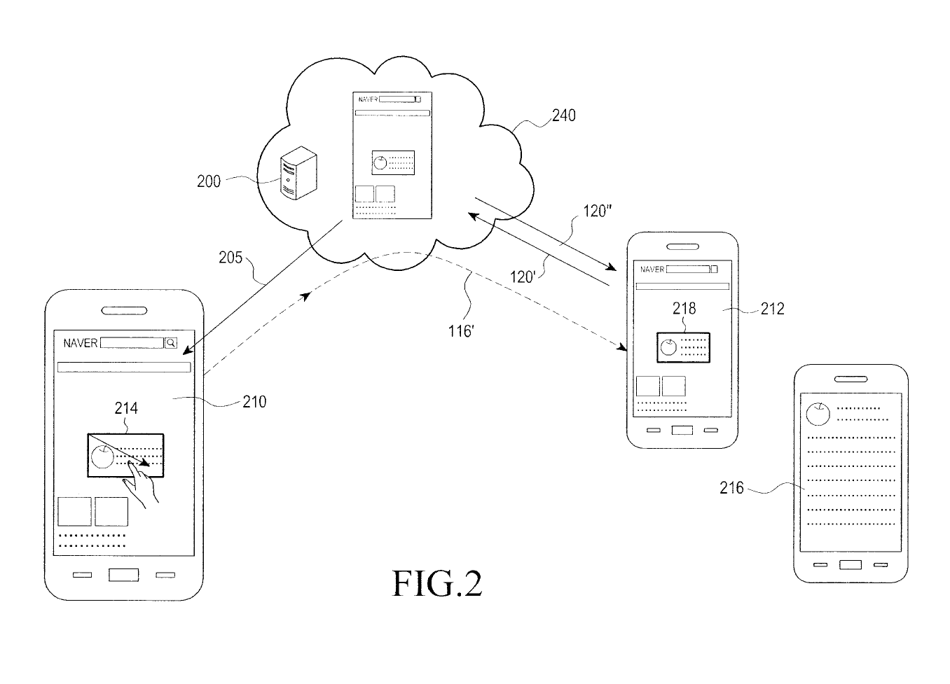

FIG. 1 is a flowchart of an example method of sharing content for a web page according to an embodiment of the present disclosure. To facilitate an understanding of the operations of the method of FIG. 1, reference will be made concurrently to the exemplary system illustrated in FIG. 2.

First, in step 110, a user accesses a wireless portal server or a wired internet server to operate a browser in order to use a wireless internet service. Here, it is assumed that the user accesses a wired internet web server based on an HTTP (Hyper Text Transport Protocol) by using a terminal having a browser, but the present invention is not limited thereto. Access can alternatively be made to, e.g., to a wireless portal server of a mobile communication association based on a WAP (Wireless Application Protocol) or an affiliated content provider. In any case, a web page of the web server downloaded from the server to the portable terminal (first terminal) and displayed on the portable terminal screen through the operation of step 110. This is illustrated in FIG. 2, where a server 200 of an IP network 240 such as the World Wide Web downloads a web page to a user terminal 210 (first terminal), as illustrated by path 205.

With the web page displayed on the first terminal, the user separately selects a predetermined region containing the contents which the user desires to share with outside terminals, in step 112. Examples of contents contained within the selected region include image data, text data, video data, and flash data included in the corresponding web page.

The region selected by the user is selected through one or more pointing operations such as a touch, a tap, a flick, or a drag-and-drop generated on a touch screen due to a touch of the user in a specific region of the web page displayed on the touch screen. This operation is illustrated in FIG. 2, where it is seen that a user has selected content corresponding to the region 214 via touch input. The user can also browse by moving a cursor via touch input and tapping or clicking, or via other user input means such as a touch pen, etc.

Next, in step 114, “region information” corresponding to the region selected by the user is extracted. The extracted region information refers to size information of the region within the displayed web page (relative to the overall web page dimensions) and coordinate information corresponding to the selected region. Note that the web page is displayed after original reference coordinate information of the corresponding web page (i.e., provided by the server) is changed according to a size of a web page display area in the terminal Thus when the region information for the predetermined region selected by the user is extracted from the web page, it represents a measurement in relation to the size of the web page display area of the terminal. Thus the region information includes suitable accompanying information, such that it represents a precise region of the entire web page rather than a region of a partially displayed web page (as may be displayed on a small display).

In step 116, corresponding URL information of the web page, or of the web page fragment within which the region is included, is mapped to the extracted region information. The mapped information can contain a URL address to be shared and an HTML part coordinate to be shared. For example, the URL information can be mapped in a form of (http://cloud,com/a, 234, 456, 324, 654). The extracted region, URL information is then transmitted to the other terminal (second terminal).This is illustrated in FIG. 2 by path 116′ representing the transmission of the respective information pertaining to region 214 selected from the display of terminal 210. This information is transmitted to second terminal 212 by means of IP network 240. Examples of suitable means to transfer the information along path 116′ to an intended recipient include commonly used links such as links for text messaging and email. The content sharing operation can be run in special content sharing modes in the transmitting (first) and receiving (second) terminals. A dedicated content sharing software program can be configured and run on both the transmitting and receiving terminals, such that with adequate signaling, the region, URL information can be immediately recognized by the receiving terminal as special content sharing information. With these programs running or initiated via reception of a recognized signal, as soon as the region and URL information is received, it is recognized and the receiving terminal can immediately respond by launching its web browser to initiate the request to the server for the web page.

Subsequently, in step 118, the extracted region and URL information, and optional HTML information transmitted in step 116 and received by the second terminal, is parsed by the second terminal.

In step 120, a web page corresponding to the parsed URL information is requested by the second terminal from the web server. The server responds by transmitting the requested web page to the second terminal, where it is received. As shown in FIG. 2, the request to server 200 from second terminal 212 is illustrated by path 120′ and the response by the server to download the web page by path 120″.

In step 122, a region of the received web page corresponding to the extracted region information in the received web page is recognized by the second terminal. At this time, a region recognition corresponding to the extracted region information is performed by comparing the region extraction information parsed in step 118 with a reference coordinate of the web page provided by the web server and estimating the corresponding region in the received web page. The web server providing the web page provides the reference coordinate of the web page to a terminal which requests the corresponding web page as well. Accordingly, the coordinate information extracted based on a size of a unique display region for each terminal enables the selected region to be accurately recognized on an original web page in the terminal where the received web page is displayed (in this case, the second terminal).

In step 124, after the region selected in the first terminal is recognized from the original web page based on the reference coordinate in step 122, the recognized region is activated in the second terminal. As an example of such activation of the recognized region, a region corresponding to the extracted region information in the received web page is enlarged and then rendered. As another example, the extracted region is emphasized by either outlining, highlighting, changing the font, etc., relative to other displayed content on the downloaded web page. Outlining is illustrated in FIG, 2 as display region 218 on the screen of second terminal 212. Enlarging the region and displaying it separately without the other content of the web page is illustrated on the screen of a third terminal 216. (This assumes, in the example, that the user of terminal 212 also selected terminal 216 as another intended recipient of the shared content. In this case, transmission of the region information and URL information from first terminal 212 to third terminal 216 is made via another link, not shown in FIG. 2 but similar to link 116′.)

It is noted here that the method illustrated by FIGS. 1 and 2 can also be considered a method of sharing a content service, since the content originates from a common server providing a the same web page to multiple terminals as a service.

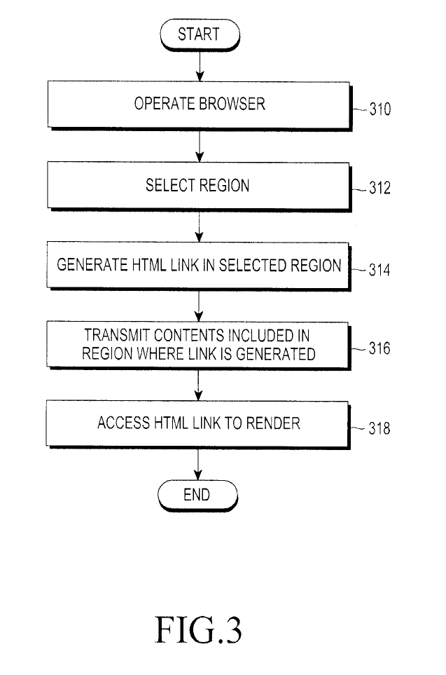

FIG. 3 is a flowchart of a method of sharing content for a web page according to another embodiment of the present disclosure. (The method can also be considered a method of sharing a content service, since the content originates from a common server providing the same web page to multiple terminals as a service.)

First, in step 310, a user of a first terminal accesses a wireless portal server or a wired internet server to drive a browser in order to use a wireless internet service. (This step is the same or similar to step 110 of FIG. 1.)

When a web page of the web server is displayed through an operation of step 310, the user separately selects a predetermined region, which corresponds to a region containing the contents which the user desires to share with outside terminals in step 312, and information corresponding to the region selected by the user is extracted in step 314. (These steps are the same or similar to steps 112 and 114 of FIG. 1.)

In step 316, contents included in a region where an HTML link is generated are transmitted, and the corresponding HTML link of the transmitted contents is accessed and a transmitted HTML file is rendered in step 318. At this time, the rendering has a meaning of enlarging the region where the HTML link is generated and then activating the enlarged region.

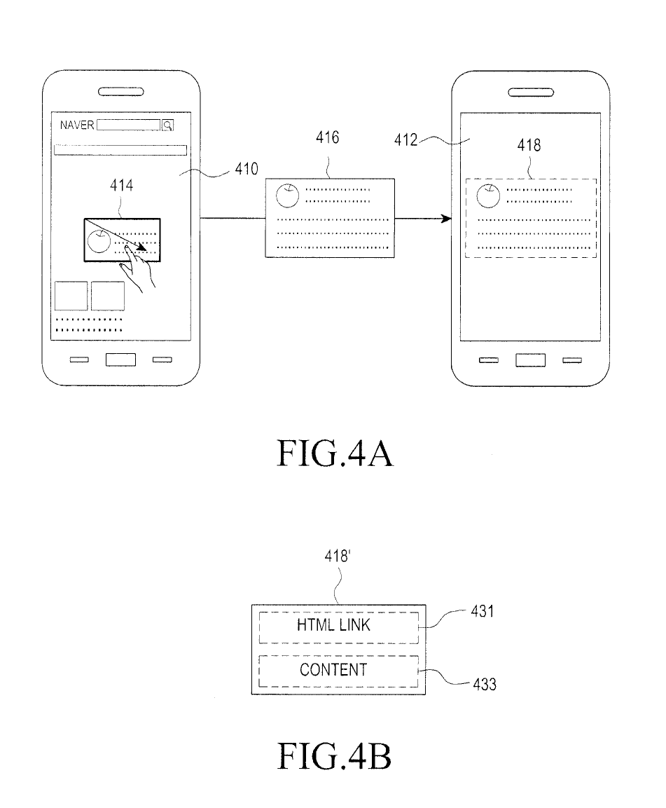

Schematically referring to operations of steps 310 to 318 through FIG. 4, when a user selects a predetermined region 414 of the web page on a screen of a user terminal 410 where the web page is displayed by using a user input means (for example, a pen or a finger), an HTML link is generated in the region selected by the user, and then an HTML file 416 where the HTML link is generated is transmitted to a terminal 412 of the reception side, the terminal 412 for the reception side accesses an address linked to the corresponding HTML file of the content-s transmitted from the user terminal, which is the terminal 410 of the transmission side, to perform a rendering as shown in FIG. 4.

It is noted here, that the method illustrated by FIGS. 3 and 4 can also be considered a method of sharing a content service, since the content originates from a common server providing the same web page to multiple terminals as a service.

Referring again to FIG. 2, a system for sharing the content service for the web page according to an embodiment of the present disclosure includes the service provider server 200 providing a corresponding web page of a URL and reference coordinate information of the web page according to a request of any one of the user terminals 210, 212, and 216. When a user selects a specific region, e.g., a user of terminal 210 selecting region 214, in which specific contents of the web page which the user desires to share with acquaintances such as families, relatives, and friends are included, through one or more pointing operations among a touch, a tap, a flick, or a drag-and-drop by using a user input means (for example, touch pen or finger) while browsing the web page displayed in the user terminal 210, the user terminals 210, 212, and 216 extract information corresponding to the region selected by the user from the web page, and map corresponding HTML URL information of the web page into the extracted information. Then, the user terminals 210, 212, and 216 transmit the selected region to a terminal with which a user desires to share the selected region, parse the mapped region extraction information and URL information, receive the corresponding web page from the service server 200 based on the URL information, recognize the region corresponding to the extracted region information in the received web page, and activate the region.

Here, the extracted information corresponds to full size information of the region in which the web page is displayed and corresponding coordinate information of the region 214 selected by the user in the web page. Since the web page is displayed after original reference coordinate information of the corresponding web page is changed according to a full size of a display region of the terminal 210 in which the web page is displayed, when the information for the predetermined region 214 selected by the user in the web page is extracted, an extraction of the coordinate information of the region selected based on the size of the display region of the corresponding terminal should be accompanied.

Meanwhile, the user terminal 212 of the reception side receives mapped information obtained by mapping the URL information into the region extraction information, and parses the mapped information. Further, the user terminal 212 of the reception side requests the corresponding web page from the server 200 based on the URL information to receive the web page, and recognizes the region corresponding to the extracted region information in the received web page.

At this time, a region recognition corresponding to the extracted region information is performed by comparing the parsed region extraction information with a reference coordinate of the web page provided by server 200 and estimating the corresponding region in the received web page. The server 200 providing the web page provides a terminal which requests the corresponding web page with the reference coordinate of the web page as well. Accordingly, the coordinate information extracted based on a size of a unique display region for each terminal enables the selected region 218 to be accurately recognized on an original web page in the terminal where the received web page is displayed.

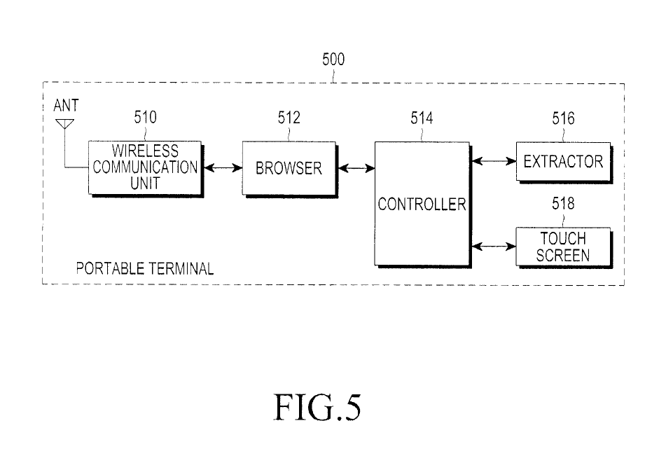

FIG. 5 is a functional block diagram of a portable terminal, 500, configured to share a content service for a web page according to an embodiment of the present disclosure. Portable terminal 500 includes a wireless communication unit 510, a browser 512, a controller 514, an extractor 516, and a touch screen 518.

The wireless communication unit 510 receives a wireless downlink signal from the air by using an antenna, and outputs downlink data obtained by demodulating the wireless downlink signal to the controller 514. Further, the wireless communication unit 510 modulates uplink data input from the controller 514 to generate the wireless uplink signal, and wirelessly transmits the generated wireless uplink signal to the air by using an antenna. Such a modulation and a demodulation may be preferably performed according to a Code Division Multiple Access (CDMA) scheme, otherwise, they may be performed according to a Frequency Division Multiplexing (FDM) scheme or a Time Division Multiplexing (TDM) scheme.

The browser 512 is connected to the service provider server 200 providing the corresponding web page of the URL and reference coordinate information of the web page in order to support a wireless internet service according to a request of the portable terminal 500.

The extractor 516 extracts information corresponding to the region selected by the user from the web page displayed in the touch screen 518. Extractor 516 can be embodied as a software module, containing program instructions to run the above-described content sharing software application for applications of both a transmitting terminal and receiving terminal, as the case may be. In other words, in a mode wherein terminal 500 is operating as the first (transmitting) terminal, i.e., initiating a content sharing operation with other terminals, extractor 516 generates and transmits appropriate signaling for transmitting region information, URL information, HTML link information, etc. to the server/receiving (second) terminal to enable the second terminal to render the selected content. For the case in which terminal 500 is operating as a receiving (second) terminal to receive content selected at another terminal, extractor 516 also operates to receive appropriate signaling to receive region and URL information, generate a command to controller 514 to begin operating the web browser to access the web page at the server, and extract the selected region from the received web page upon receipt from the server.

When the controller 514 maps the corresponding URL information of the web page to the extracted information, transmits the mapped information and receives the mapped region extraction information and URL information, the controller parses the mapped information, receives the corresponding web page from the service server based on the URL information, recognizes the region corresponding to the extracted region information in the received web page, and performs a control operation such that the region is activated.

Further, the controller 514 compares the parsed region extraction information with the reference coordinate of the web page provided from the service server, and controls such that the corresponding region is estimated in the received web page.

Here, the extracted information corresponds to full size information of the region in which the web page is displayed and corresponding coordinate information of the region selected by the user from the web page. Since the web page is displayed after original reference coordinate information of the corresponding web page is changed according to a full size of a display region mounted in the terminal in which the web page is displayed, when the information for the predetermined region selected by the user from the web page is extracted, an extraction of the coordinate information of the region selected based on the size of the display region of the corresponding terminal should be accompanied.

Accordingly, embodiments of the present disclosure have an effect of receiving an adaptive URL file rendering service for each user or group only for contents, which a user desires to share, by freely and separately selecting a plurality of contents contained in a web page and transmitting the selected contents.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Operations with regard to the method and the apparatus for sharing the content service of the web page, and the system for providing the same according to the present invention may be achieved as described above. While the present invention has been shown and described with reference to certain exemplary embodiments and drawings thereof, it will be understood by those skilled in the art that various changes in form and details may be made therein without departing from the spirit and scope of the invention as defined by the appended claims.

What is claimed is:

1. A method of sharing content of a web page between first and second terminals, the method comprising:
extracting, by the first terminal, a region information corresponding to a region selected by a user from the web page;
mapping, by the first terminal, URL information corresponding to the web page to the extracted region information and transmitting the mapped information to the second terminal; and
the second terminal parsing the mapped extracted region information and URL information, receiving the corresponding web page from a web server based on the parsed URL information, recognizing a region corresponding to the extracted region information in the received web page, and activating the region.

2. The method as claimed in claim 1, wherein the extracted region information corresponds to size information of a region where the web page is displayed and coordinate information corresponding to the region selected by the user from the web page.

3. The method as claimed in claim 1, wherein the region selected by the user is selected through one or more pointing operations among a touch, a tap, a flick, or a drag-and-drop generated on a touch screen due to a touch of the user in a specific region of the web page.

4. The method as claimed in claim 1, wherein activating of the region comprises enlarging the region corresponding to the extracted region information in the received web page and then rendering the enlarged region.

5. The method as claimed in claim 1, wherein recognizing of the region corresponding to the extracted region information is performed by comparing the parsed extracted region information with a reference coordinate of the web page provided by the web server and estimating a corresponding region in the received web page.

6. The method as claimed in claim 1, wherein the web page has a coordinate value automatically controlled according to a displayed region.

7. A method of sharing content of a web page, the method comprising:
generating, by a first terminal, an HTML link corresponding to a region of the web page selected by a user at the first terminal;
transmitting, by the first terminal, the HTML link and contents included in the region of the web page to a second terminal; and
receiving and displaying, by the second terminal, the transmitted contents of the selected region.

8. The method as claimed in claim 7, wherein the contents contain information of an image, a text, a video, a flash, and embedded contents.

9. The method as claimed in claim 7, wherein the region selected by the user is selected through one or more pointing operations among a touch, a tap, a flick, or a drag-and-drop generated on a touch screen due to a touch of the user in a specific region of the web page.

10. The method as claimed in claim 7, wherein performing of the rendering comprises enlarging a region where the HTML link is generated and activating the enlarged region.

11. A system for sharing a content service for a web page, the system comprising:
a server to provide a web page corresponding to a URL and reference coordinate information of the web page according to a request of a user terminal; and
a user terminal to extract region information corresponding to a region selected by a user from the web page, map URL information corresponding to the web page to the extracted region information, transmit the selected region information to a second terminal with which the user desires to share contents of the selected region, the second terminal parsing the mapped extracted region information and URL information, receiving a corresponding web page from a web server based on the URL information, recognizing a region corresponding to the extracted region information in the received web page, and activating the region.

12. The system as claimed in claim 11, wherein the extracted region information corresponds to size information of a region where the web page is displayed and coordinate information corresponding to the region selected by the user from the web page.

13. The system as claimed in claim 11, wherein the user terminal recognizes the region corresponding to the extracted region information by comparing the parsed extracted region information with a reference coordinate of the web page provided by the web server and estimating a corresponding region in the received web page.

14. A portable terminal configured to share content of a web page with a receiving terminal, the portable terminal comprising:
a touch screen;
a browser for accessing a server providing the web page corresponding to a URL and reference coordinate information of the web page in order to support a wireless internet service according to a request of a user terminal;
an extractor for extracting region information corresponding to a region selected by a user from the web page displayed on the touch screen; and
a controller for mapping corresponding URL information of the web page into the extracted region information, transmitting the mapped extracted region information and URL information, parsing the mapped extracted region information and URL information when receiving the mapped extracted region information and URL information, receiving a corresponding web page from a web server based on the URL information, recognizing a region corresponding to the extracted region information in the received web page, and controlling such that the region is activated.

15. The apparatus as claimed in claim 14, wherein the controller compares the parsed extracted region information with a reference coordinate of the web page provided by the web server, and controls such that a corresponding region is estimated in the received web page.

16. The apparatus as claimed in claim 14, wherein the extracted region information corresponds to size information of a region where the web page is displayed and coordinate information corresponding to the region selected by the user in the web page.
